(19) United States
(12) Patent Application Publication
(10) Pub. No.: US 2023/0093544 A1
(43) Pub. Date: Mar. 23, 2023

(54) Random Number Generation Apparatus and Method

(71) Applicant: Huawei Technologies Co., Ltd., Shenzhen (CN)

(72) Inventors: Girish Shivalingappa Revadigar, Singapore (SG); Zhuo Wei, Singapore (SG); Zhen Li, Shanghai (CN); Xinxing Yin, Shanghai (CN)

(21) Appl. No.: 17/993,550

(22) Filed: Nov. 23, 2022

Related U.S. Application Data
(63) Continuation of application No. PCT/CN2020/092729, filed on May 27, 2020.

(51) Int. Cl. G06F 7/58

(52) U.S. Cl. CPC G06F 7/58

(57) ABSTRACT

A random number generation apparatus includes an electric network frequency (ENF) extractor, an entropy generation module, and an entropy pool. The random number generation apparatus may generate a true random number and a pseudo random number based on an ENF signal of an electric network without using a hardware entropy source.

### CROSS-REFERENCE TO RELATED APPLICATIONS

This application is a continuation of International Patent Application No. PCT/CN2020/092729, filed on May 27, 2020, the disclosure of which is hereby incorporated by reference in its entirety.

### TECHNICAL FIELD

The present disclosure relates to the field of electronic technologies, and in particular, to a random number generation apparatus and method.

### BACKGROUND

Currently, communication can be performed between a vehicle and an external device, and between components inside the vehicle. Some communication processes require high security, and therefore need to use a proper security mechanism. Usually, most security mechanisms rely on random numbers. For example, a random number may be used as an initialization vector, a session identifier, or a basic unit for key generation and verification. The randomness of the random number may be represented by an entropy of the random number. Usually, a higher entropy of the random number indicates that a security mechanism depending on the random number is less likely to be cracked, and security of the random number is higher. Therefore, whether the random number can have a high entropy is very important for security of vehicle communication.

Usually, entropy bit data may be generated by adding a hardware entropy source to the vehicle, and a random number is generated after a specific operation is performed on the entropy bit data. An entropy of the random number mainly depends on an entropy of the entropy bit data. Therefore, currently, a high-quality hardware entropy source needs to be configured in most vehicles, which is not conducive to reducing production costs of the vehicles.

In conclusion, currently, generation of a random number in a vehicle needs to be further studied.

### SUMMARY

The present disclosure provides a random number generation apparatus and method, to generate a true random number and a pseudo random number without using a hardware entropy source.

According to a first aspect, an embodiment of this application provides a random number generation apparatus. The apparatus mainly includes an electric network frequency (ENF) extractor, an entropy generation module, and an entropy pool. An input end of the ENF extractor is connected to an electric network, an output end of the ENF extractor is connected to an input end of the entropy generation module, and an output end of the entropy generation module is connected to the entropy pool. The ENF extractor may extract an ENF signal of the electric network. The entropy generation module may generate first bit data based on the ENF signal. The entropy pool may receive at least one piece of input data, where the at least one piece of input data includes the first bit data; and generate a random number based on the at least one piece of input data.

The ENF signal of the electric network changes with an electricity requirement of a user in the electric network, and the electric network carries a large quantity of users. Therefore, it may be considered that an overall electricity requirement of the users in the electric network is irregular, and further, the first bit data with true randomness may be generated based on the ENF signal. In this embodiment of this application, the at least one piece of input data received by the entropy pool includes the first bit data. Therefore, the entropy pool may generate a true random number and a pseudo random number based on the first bit data. Therefore, by using the random number generation apparatus provided in this embodiment of this application, a true random number and a pseudo random number can be generated without using a hardware entropy source.

For generating a true random number, the entropy pool may include a first operational circuit, the first operational circuit is connected to the output end of the entropy generation module, and the first operational circuit may generate a first random number based on the first bit data, where the first random number is a true random number. Because the first bit data has true randomness, the first operational circuit may generate the first random number with true randomness based on the first bit data.

For example, the entropy pool may further include a deterministic random bit generator DRBG, and the DRBG is separately connected to the output end of the entropy generation module and the first operational circuit. The DRBG may generate second bit data based on the first bit data. When generating the first random number, the first operational circuit may perform an exclusive OR operation on the current first bit data and the second bit data, to generate the first random number. It should be noted that the current first bit data is real-time bit data, that is, first bit data output by the DRBG when the exclusive OR operation is performed.

For generating a pseudo random number, the entropy pool may further include a storage area and an interface circuit. The DRBG may correspondingly generate at least one piece of third bit data based on the at least one piece of input data, where the at least one piece of third bit data includes the second bit data. The storage area may store the at least one piece of third bit data. After receiving a pseudo random number request message, the interface circuit may randomly read third bit data from the storage area, and output a second random number based on the randomly read third bit data, where the second random number is a pseudo random number.

For example, the storage area includes a first storage area and a second storage area. The first storage area may store third bit data that has an entropy rate greater than a first threshold, and the second storage area may store third bit data that has an entropy rate not greater than the first threshold. In this case, based on an entropy rate corresponding to the at least one piece of third bit data, the DRBG may further separately store third bit data that is in the at least one piece of third bit data and that has an entropy rate greater than the first threshold into the first storage area, and store third bit data that is in the at least one piece of third bit data and that has an entropy rate not greater than the first threshold into the second storage area.

Based on this storage manner, the pseudo random number request message may be a full-entropy pseudo random number request message or a reduced-entropy pseudo random number request message. After receiving the full-entropy pseudo random number request message, the interface circuit may randomly read the third bit data from the first storage area, and output the second random number based on the randomly read third bit data. Alternatively, after receiving the reduced entropy pseudo random number request message, the interface circuit may randomly read the third bit data from the second storage area, and output the second random number based on the randomly read third bit data.

In this embodiment of the present disclosure, the entropy generation module may include an analog-to-digital converter and a second operational circuit. The analog-to-digital converter may convert the ENF signal from an analog signal into a digital signal. The second operational circuit may perform an operation on the ENF signal that is converted into the digital signal, to obtain the first bit data.

For example, the analog-to-digital converter may perform multi-bit (M-bit) quantization processing on the ENF signal in an analog signal form, to convert the ENF signal into a digital signal form. The ENF signal in the digital signal form carries a bit stream, and the second operational circuit may perform an operation on the bit stream according to an entropy conditioning algorithm, to obtain conditioned full entropy bits, that is, the first bit data.

To further improve quality of the random number, in a possible implementation, the entropy generation module may further include a preprocessing circuit, and the preprocessing circuit is separately connected to the ENF extractor and the analog-to-digital converter. The preprocessing circuit may preprocess the ENF signal, and output the preprocessed ENF signal to the analog-to-digital converter.

By preprocessing, processing such as filtering and enhancement may be performed on the ENF signal to remove noise or a useless component from the ENF signal. For example, a random or abnormal peak pulse, a ghost signal, and the like in the ENF signal can be removed, so that quality of the first bit data can be improved.

To detect an abnormal risk in a timely manner, in a possible implementation, the preprocessing circuit may further detect signal quality of the ENF signal; and continue or stop, based on the signal quality of the ENF signal, outputting the ENF signal to the analog-to-digital converter.

Specifically, the preprocessing circuit may continuously monitor the ENF signal, to ensure that the preprocessed ENF signal output to the analog-to-digital converter has enough randomness. For example, when the electric network is powered off or the ENF extractor is abnormal (for example, faulty or powered off), or when an attacker attempts to control the ENF signal to affect random number generation, the preprocessing circuit may monitor the ENF signal to determine signal quality of the ENF signal, for example, randomness quality and an attribute (for example, repeatability) of the ENF signal, so as to detect a possible risk in a timely manner. When quality of the ENF signal is not high, there may be an abnormal risk. In this case, the preprocessing circuit may stop outputting the ENF signal to the analog-to-digital converter, to reduce a risk of a security mechanism being cracked.

According to a second aspect, an embodiment of the present disclosure provides a random number generation method. The method may be applied to the random number generation apparatus provided in any implementation of the first aspect. For a technical effect of a corresponding solution in the second aspect, refer to a technical effect that can be obtained by using the corresponding solution in the first aspect. Details are not described herein. For example, the random number generation method provided in this embodiment of the present disclosure mainly includes the following step: obtaining at least one piece of input data, where the at least one piece of input data includes first bit data, and the first bit data may be generated based on an ENF signal of an electric network; and generating a random number based on the foregoing at least one piece of input data.

Because the ENF signal of the electric network used in this embodiment of the present disclosure has true randomness, the first bit data also has true randomness. Therefore, when the random number is output based on the at least one piece of input data, the first random number may be generated based on the first bit data, and the first random number may be a true random number.

For example, when the first random number is generated based on the first bit data, second bit data may be generated based on the first bit data; and an exclusive OR operation is performed on the current first bit data and the second bit data, to generate the first random number.

The random number generation method provided in this embodiment of the present disclosure may further generate a pseudo random number. For example, when the second bit data is generated based on the first bit data, at least one piece of third bit data may be correspondingly generated based on the at least one piece of input data, where the at least one piece of third bit data includes the second bit data; and then the at least one piece of third bit data is stored. After receiving a pseudo random number request message, third bit data may be randomly read from the at least one piece of stored third bit data, and a second random number is output based on the randomly read third bit data, where the second random number is a pseudo random number.

For example, when the at least one piece of third bit data is stored, based on an entropy rate corresponding to the at least one piece of third bit data, third bit data that is in the at least one piece of third bit data and that has an entropy rate greater than a first threshold may be stored into a first storage area, and third bit data that is in the at least one piece of third bit data and that has an entropy rate not greater than the first threshold may be stored into a second storage area.

In view of this, the pseudo random number request message may be a full-entropy pseudo random number request message or a reduced-entropy pseudo random number request message. After the full-entropy pseudo random number request message is received, the third bit data may be randomly read from the first storage area; and after the reduced-entropy pseudo random number request message is received, the third bit data may be randomly read from the second storage area.

To further improve quality of the first bit data, in a possible implementation, before the at least one piece of input data is obtained, the ENF signal may be first converted from an analog signal into a digital signal; and an operation is performed on the ENF signal that is converted into the digital signal, to obtain the first bit data.

To further improve quality of the first bit data, in a possible implementation, the ENF signal may be preprocessed first, and then the preprocessed ENF signal is converted from an analog signal into a digital signal.

To detect an abnormal risk in a timely manner, in a possible implementation, signal quality of the ENF signal may be first detected, and then conversion of the ENF signal from the analog signal to the digital signal is continued or stopped based on the signal quality of the ENF signal.

These aspects or other aspects in the present disclosure may be clearer and more intelligible in descriptions in the following embodiments.

### BRIEF DESCRIPTION OF DRAWINGS

FIG. 1 is a schematic diagram of a structure of a random number generation apparatus according to an embodiment of the present disclosure;

FIG. 2 is a schematic diagram of a specific structure of a random number generation apparatus according to an embodiment of the present disclosure;

FIG. 3 is a schematic diagram of a structure of a preprocessing circuit according to an embodiment of the present disclosure;

FIG. 4 is a schematic diagram of a structure of an entropy pool according to an embodiment of the present disclosure; and

FIG. 5 is a schematic flowchart of a random number generation method according to an embodiment of the present disclosure.

### DESCRIPTION OF EMBODIMENTS

Information security plays an important role in many types of electronic devices. For example, hundreds or thousands of electronic control units (ECUs) are integrated in a green car, and the electronic control units have a plurality of external communications interfaces such as vehicle-to-external-device, vehicle-to-vehicle, and vehicle-to-infrastructure. In addition, there are internal networks such as controller area network (CAN), local interconnect network (LIN), and Ethernet in green cars. Regardless of the external communications interfaces or the internal networks, specified security mechanisms are required during communication to ensure confidentiality, authenticity, and integrity of messages or data.

In a current communication security mechanism, a random number is a basis of a security mechanism in many electronic devices. For example, a random number may be used as an initialization vector, a session identifier, or a basic unit for key generation and verification. Usually, a higher quality of the random number indicates that the security mechanism based on the random number is less likely to be cracked. A quality of the random number may be understood as randomness of the random number, that is, an entropy of the random number. A higher entropy of the random number indicates higher quality of the random number. On the contrary, a lower entropy of the random number indicates lower quality of the random number.

Random numbers can be classified into true random numbers and pseudo random numbers based on generation modes of the random numbers. The true random number is a random number generated by using a physical phenomenon, and a value of the random number is totally unpredictable, and has real randomness. For example, thermal noise generated in a circuit, a decay process of a radioactive element, or timing information related to counting of a Geiger counter can be used to generate a true random number.

A pseudo random number is a random number generated by using a random algorithm. Although a pseudo random number may also have a high entropy or even a full entropy, the pseudo random number is generated according to an algorithm. Therefore, a value of the random number is theoretically predictable and does not have real randomness.

It can be learned that compared with the pseudo random number, the true random number can provide higher security assurance for the electronic devices. Therefore, a high-quality hardware entropy source is disposed in some electronic devices to generate true random numbers. However, this implementation increases system complexity of the electronic device, and also increases manufacturing costs of the electronic device.

In view of this, an embodiment of the present disclosure provides a random number generation apparatus. The random number generation apparatus may be a chip or a module in an electronic device, or may be an electronic device (for example, an electronic device such as a green car, the internet of things (IoT) device, a smart appliance, or an autonomous vehicle) that can connect to an electric network. This is not limited in this embodiment of the present disclosure. The random number generation apparatus provided in this embodiment of the present disclosure may generate a random number based on an ENF signal. The ENF signal of the electric network changes with an electricity requirement of a user in the electric network, and the electric network carries a large quantity of users. Therefore, it may be considered that an overall electricity requirement of the users in the electric network is irregular, and further, a true random number may be generated based on the ENF signal.

To make the objectives, technical solutions, and advantages of the present disclosure clearer, the following further describes the present disclosure in detail with reference to the accompanying drawings. A specific operation method in a method embodiment may also be applied to an apparatus embodiment or a system embodiment. It should be noted that in description of the present disclosure, “at least one” means one or more, and “a plurality of” means two or more. In view of this, in embodiments of the present disclosure, “a plurality of” may also be understood as “at least two”. The term “and/or” describes an association relationship for describing associated objects and represents that three relationships may exist. For example, A and/or B may represent the following three cases: Only A exists, both A and B exist, and only B exists. In addition, the character “/”, unless otherwise specified, generally represents an “or” relationship between the associated objects. In addition, it should be understood that in description of the present disclosure, terms such as “first” and “second” are merely used for distinguishing and description, but should not be understood as indicating or implying relative importance, or should not be understood as indicating or implying a sequence.

It should be noted that the “connection” in embodiments of the present disclosure refers to an electric connection, and the connection between two electrical elements may be a direct or indirect connection between the two electrical elements. For example, a connection between A and B may represent that A and B are directly connected to each other, or A and B are indirectly connected to each other by using one or more other electrical elements. For example, the connection between A and B may also represent that A is directly connected to C, C is directly connected to B, and A and B are connected to each other through C.

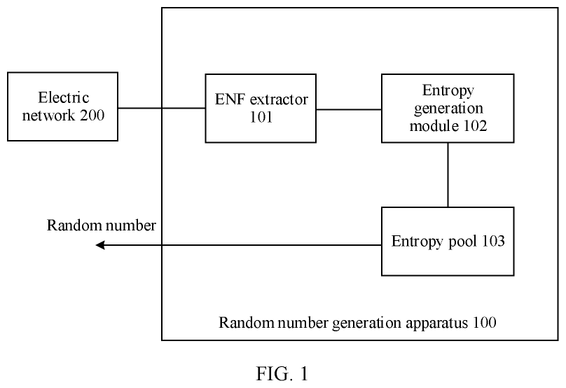

FIG. 1 shows an example of a schematic diagram of a structure of a random number generation apparatus according to an embodiment of the present disclosure. As shown in FIG. 1, the random number generation apparatus 100 mainly includes an ENF extractor 101, an entropy generation module 102, and an entropy pool 103. An output end of the ENF extractor 101 is connected to an input end of the entropy generation module 102, and an output end of the entropy generation module 102 is connected to the entropy pool 103.

The following separately describes the ENF extractor 101, the entropy generation module 102, and the entropy pool 103 as examples.

1. ENF Extractor 101:

The ENF extractor 101 may be connected to an electric network, and the ENF extractor 101 may extract an ENF signal from the electric network. Signal strength of the ENF signal may represent an ENF change. For example, if the ENF is 50 hertz (Hz), the frequency of the ENF signal is also 50 Hz.

In this embodiment of the present disclosure, the electric network to which the ENF extractor 101 is connected may supply power to a large quantity of users. For example, the electric network may be a large electric network such as an urban electric network. When a power consumption of a user changes, the ENF also changes. That is, the ENF fluctuates within a specified range. Because there is a large quantity of users in the electric network, the power consumption of the users in the electric network is usually unpredictable. That is, the ENF is completely random. Therefore, the signal strength of the ENF signal extracted by the ENF extractor 101 from the electric network is also completely random.

2. Entropy Generation Module 102:

The entropy generation module 102 may generate first bit data based on the ENF signal provided by the ENF extractor 101. In this embodiment of the present disclosure, because signal strength of the ENF signal is completely random, the entropy generation module 102 may generate, based on the ENF signal, the first bit data that has true randomness.

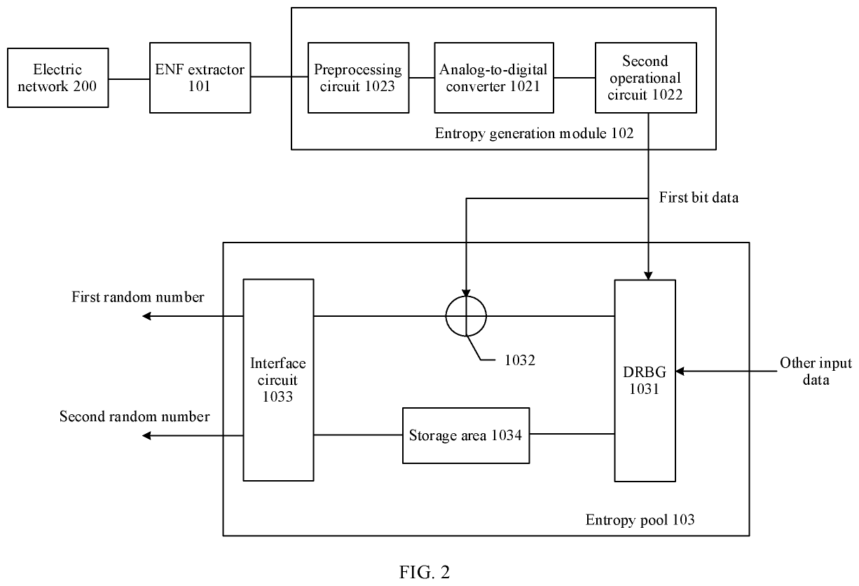

For example, as shown in FIG. 2, the entropy generation module 102 may include an analog-to-digital converter 1021 and a second operational circuit 1022. An input end of the analog-to-digital converter 1021 is connected to the ENF extractor 101, and an output end of the analog- to-digital converter 1021 is connected to the second operational circuit 1022.

The analog-to-digital converter 1021 may convert the ENF signal from an analog signal to a digital signal. For example, the analog-to-digital converter 1021 may perform M-bit quantization processing on the ENF signal in an analog signal form, to obtain an ENF signal in a digital signal form. The ENF signal in the digital signal form may carry a bit stream, for example, 0101100101.

The second operational circuit 1022 may perform an operation on the ENF signal that is converted into the digital signal, to obtain the first bit data. For example, the second operational circuit 1022 may perform an operation according to an entropy conditioning algorithm based on the bit stream carried in the ENF signal that is converted into the digital signal, to obtain conditioned full entropy bits, that is, the first bit data. The entropy conditioning algorithm used by the second operational circuit 1022 may be an algorithm such as a secure hash algorithm (SHA)-256. This is not limited in this embodiment of the present disclosure. A deviation in the bit data may be removed by performing an operation according to the entropy conditioning algorithm, to output conditioned full entropy bits with a high entropy value (approximately equal to 1 bit/bit), that is, the first bit data.

To further improve quality of the first bit data, in a possible implementation, the entropy generation module 102 may further include a preprocessing circuit 1023. As shown in FIG. 2, an input end of the preprocessing circuit 1023 is connected to the ENF extractor 101, and an output end of the preprocessing circuit 1023 is connected to the entropy generation module 102.

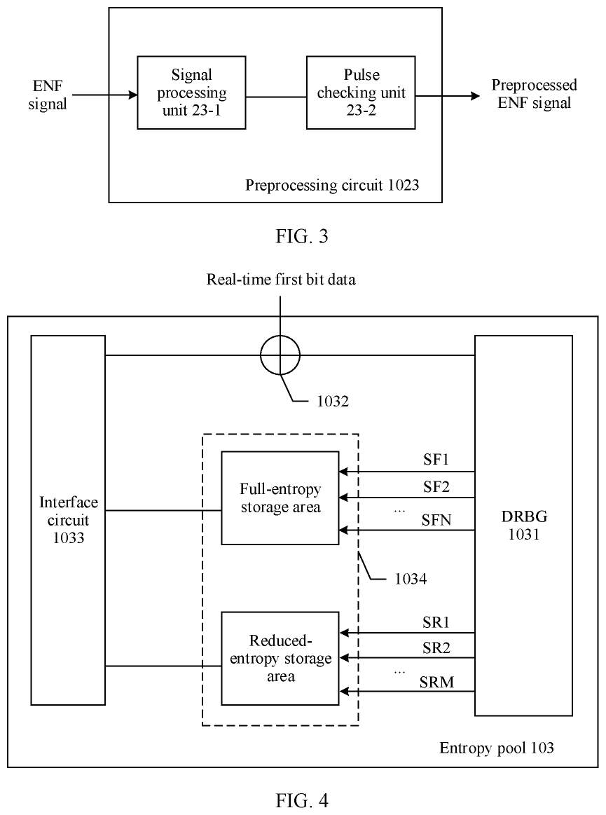

The preprocessing circuit 1023 may preprocess the ENF signal provided by the ENF extractor 101, and output the preprocessed ENF signal to the analog-to-digital converter 1021. For example, as shown in FIG. 3, the preprocessing circuit 1023 may include a signal processing unit 23-1. The signal processing unit 23-1 may perform processing such as filtering and enhancement on the ENF signal to remove noise or a useless component from the ENF signal. For example, a random or abnormal peak pulse, a ghost signal, and the like in the ENF signal can be removed, so that quality of the first bit data can be improved.

In a possible implementation, the preprocessing circuit 1023 may further detect signal quality of the ENF signal; and continue or stop, based on the signal quality of the ENF signal, outputting the ENF signal to the analog-to-digital converter 1021. For example, as shown in FIG. 3, the preprocessing circuit 1023 includes the signal processing unit 23-1 and a pulse checking unit 23-2. The signal processing unit 23-1 may continuously sample the ENF signal to obtain ENF sample data. The pulse checking unit 23-2 may continuously monitor the ENF sample data, to ensure that the preprocessed ENF signal output to the analog-to-digital converter 1021 has enough randomness.

For example, when the electric network is powered off or the ENF extractor 101 is abnormal (for example, faulty or powered off), or when an attacker attempts to control the ENF signal to affect random number generation, the pulse checking unit 23-2 may check randomness of the ENF sample data to determine signal quality of the ENF signal, for example, randomness quality and an attribute (for example, repeatability) of the ENF signal, so as to detect a possible risk in a timely manner. When quality of the ENF signal is not high, there may be an abnormal risk. In this case, the pulse checking unit 23-2 may stop outputting the ENF signal to the analog-to-digital converter 1021, to reduce a risk of a security mechanism being cracked.

3. Entropy Pool 103:

In this embodiment of the present disclosure, the entropy pool 103 may receive at least one piece of input data. Different input data may be from a same entropy source or different entropy sources. For example, the at least one piece of input data received by the entropy pool 103 may include the first bit data, and an entropy source corresponding to the first bit data is the ENF signal of the electric network. Other input data may be from another type of entropy source. This is not limited in this embodiment of the present disclosure.

It should be noted that the entropy pool 103 provided in this embodiment of the present disclosure may generate both a true random number and a pseudo random number.

The following describes the details based on different cases.

True random number:

As shown in FIG. 2, the entropy pool 103 includes a first operational circuit 1032, and the first operational circuit 1032 is connected to the output end of the entropy generation module 102. The first operational circuit 1032 may receive real-time first bit data from the entropy generation module 102. The first bit data has true randomness. Therefore, the first operational circuit 1032 may generate a first random number with true randomness by performing an operation on the current first bit data. In other words, the first random number is a true random number.

For example, as shown in FIG. 2, the entropy pool 103 may further include a deterministic random bit generator (DRBG) 1031, and the first operational circuit 1032 is further connected to an output end of the DRBG 1031. The DRBG 1031 may be a DRBG approved by the National Institute of Standards and Technology (NIST). The DRBG 1031 may generate second bit data based on the first bit data. In addition, because the first bit data has true randomness, the second bit data output by the DRBG 1031 may be a full-entropy pseudo random number with a highest entropy value (approximately equal to 1 bit/bit).

In this case, the first operational circuit 1032 may perform an exclusive OR operation on the current first bit data and third bit data, to generate the first random number. It should be noted that the current first bit data is real-time bit data, that is, first bit data output by the DRBG 1031 when the exclusive OR operation is performed. Because the current first bit data has true randomness, and the third bit data is a full-entropy pseudo random number, it may be considered that the first random number has true randomness, that is, the first random number is a true random number.

As shown in FIG. 2, the entropy pool 103 may further include an interface circuit 1033. After receiving a true random number request message, the interface circuit 1033 may receive the first random number from the first operational circuit 1032 and output the first random number.

Pseudo Random Number:

In this embodiment of the present disclosure, the DRBG 1031 may correspondingly generate at least one piece of third bit data based on the at least one piece of received input data. For example, if the DRBG 1031 receives input data A to C, the DRBG 1031 may generate second bit data a based on the input data A, generate second bit data b based on the input data B, and generate second bit data c based on the input data C. In this case, the third bit data generated by the DRBG 1031 based on the first bit data (included in the at least one piece of input data) may be understood as the second bit data.

The at least one piece of second bit data output by the DRBG 1031 has pseudo randomness, that is, the at least one piece of third bit data is a pseudo random number. As shown in FIG. 2, the entropy pool 103 may further include a storage area 1034, and the storage area 1034 may store at least one piece of third bit data output by the DRBG 1031.

In this case, the interface circuit 1033 may randomly read a piece of third bit data from the storage area. The interface circuit 1033 may output the randomly read third bit data as a second random number, or may generate the second random number after performing a further operation on the randomly read third bit data, and output the second random number. This is not much limited in this embodiment of the present disclosure.

In a possible implementation, as shown in FIG. 4, the storage area 1034 includes a full-entropy storage area and a reduced-entropy storage area. The DRBG 1031 may separately store each piece of third bit data in the full-entropy storage area or the reduced-entropy storage area based on an entropy rate of each piece of third bit data in the at least one piece of third bit data.

Specifically, because the at least one piece of input data received by the DRBG 1031 may be from different entropy sources, and the different entropy sources have different randomness, the at least one piece of third bit data correspondingly generated by the DRBG 1031 may have different randomness, that is, the at least one piece of third bit data may have different entropy rates.

In this embodiment of the present disclosure, the full-entropy storage area may store third bit data that has an entropy rate greater than a first threshold, and the reduced-entropy storage area may store third bit data that has an entropy rate not greater than the first threshold. As shown in FIG. 4, the DRBG 1031 may output M+N pieces of third bit data, where both M and N are integers greater than or equal to 1. Third bit data SF1 to third bit data SFN have entropy rates greater than the first threshold, and therefore may be stored in the full-entropy storage area. Third bit data SR1 to third bit data SRM have entropy rates not greater than the first threshold, and therefore may be stored in the reduced-entropy storage area.

In this case, a random number request message received by the interface circuit 1033 may be a full-entropy pseudo random number request message or a reduced-entropy pseudo random number message. After receiving the full entropy pseudo random number request message, the interface circuit 1033 may randomly read third bit data from the full-entropy storage area, and output a third random number based on the randomly read third bit data. After receiving the reduced-entropy pseudo random number request message, the interface circuit 1033 may randomly read third bit data from the reduced-entropy storage area, and output a third random number based on the randomly read third bit data.

In this implementation, the interface circuit 1033 may be enabled to output third random numbers with different entropy rates, so as to respond to random number requests in a plurality of application scenarios.

Based on a same technical concept, an embodiment of the present disclosure further provides a random number generation method. The random number generation method may be applied to any random number generation apparatus provided in the foregoing embodiment of the present disclosure. For specific implementation of the method embodiment, refer to the foregoing apparatus embodiment. Details are not repeated.

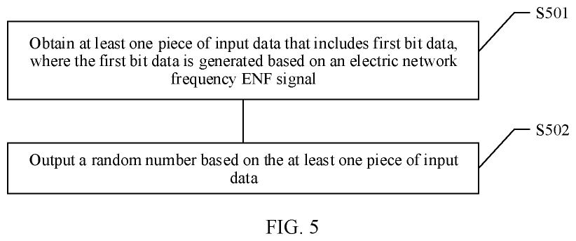

For example, as shown in FIG. 5, the random number generation method provided in this embodiment of the present disclosure mainly includes the following steps.

S501: Obtain at least one piece of input data that includes first bit data, where the first bit data is generated based on an ENF signal.

S502: Output a random number based on the at least one piece of input data.

Because the ENF signal of the electric network used in this embodiment of the present disclosure has true randomness, the first bit data also has true randomness. Therefore, when the random number is output based on the at least one piece of input data, a first random number may be generated based on the first bit data, and the first random number may be a true random number.

For example, when the first random number is generated based on the first bit data, second bit data may be generated based on the first bit data; and an exclusive OR operation is performed on the current first bit data and the second bit data, to generate the first random number.

The random number generation method provided in this embodiment of the present disclosure may further generate a pseudo random number. For example, when the second bit data is generated based on the first bit data, at least one piece of third bit data may be correspondingly generated based on the at least one piece of input data, where the at least one piece of third bit data includes the second bit data; and then the at least one piece of third bit data is stored. After receiving a pseudo random number request message, third bit data may be randomly read from the at least one piece of stored third bit data, and a second random number is output based on the randomly read third bit data, where the second random number is a pseudo random number.

For example, when the at least one piece of third bit data is stored, based on an entropy rate of the at least one piece of third bit data, third bit data that is in the at least one piece of third bit data and that has an entropy rate greater than a first threshold may be stored into a first storage area, and third bit data that is in the at least one piece of third bit data and that has an entropy rate not greater than the first threshold may be stored into a second storage area.

In view of this, the pseudo random number request message may be a full-entropy pseudo random number request message or a reduced-entropy pseudo random number request message. After the full-entropy pseudo random number request message is received, the third bit data may be randomly read from the first storage area; and after the reduced-entropy pseudo random number request message is received, the third bit data may be randomly read from the second storage area.

In a possible implementation, before the at least one piece of input data is obtained, the ENF signal may be first converted from an analog signal into a digital signal; and an operation is performed on the ENF signal that is converted into the digital signal, to obtain the first bit data.

To further improve quality of the random number, in a possible implementation, the ENF signal may be preprocessed first, and then the preprocessed ENF signal is converted from an analog signal into a digital signal.

To detect an abnormal risk in a timely manner, in a possible implementation, signal quality of the ENF signal may be first detected, and then conversion of the ENF signal from the analog signal to the digital signal is continued or stopped based on the signal quality of the ENF signal.

A person skilled in the art should understand that embodiments of the present disclosure may be provided as a method, a system, or a computer program product. Therefore, the present disclosure may use a form of hardware only embodiments, software only embodiments, or embodiments with a combination of software and hardware. In addition, the present disclosure may use a form of a computer program product that is implemented on one or more computer-usable storage media (including but not limited to a disk memory, a compact disc read-only memory (CD-ROM), an optical memory, and the like) that include computer-usable program code.

The present disclosure is described with reference to the flowcharts and/or block diagrams of the method, the device (system), and the computer program product according to the present disclosure. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

These computer program instructions may be stored in a computer-readable memory that can indicate the computer or any other programmable data processing device to work in a specific manner, so that the instructions stored in the computer-readable memory generate an artifact that includes an instruction apparatus. The instruction apparatus implements a specific function in one or more processes in the flowcharts and/or in one or more blocks in the block diagrams.

The computer program instructions may alternatively be loaded onto a computer or another programmable data processing device, so that a series of operations and steps are performed on the computer or the another programmable device, so that computer-implemented processing is generated. Therefore, the instructions executed on the computer or the another programmable device provide steps for implementing a specific function in one or more procedures in the flowcharts and/or in one or more blocks in the block diagrams.

Clearly, a person skilled in the art can make various modifications and variations to the present disclosure without departing from the protection scope of the present disclosure. This application is intended to cover the modifications and variations of the present disclosure provided that they fall within the scope of the following claims and equivalent technologies of the present disclosure.

What is claimed is:

1. A random number generation apparatus, comprising an electric network frequency (ENF) extractor, an entropy generation module, and an entropy pool, wherein an input end of the ENF extractor is connected to an electric network, an output end of the ENF extractor is connected to an input end of the entropy generation module, and an output end of the entropy generation module is connected to the entropy pool;
the ENF extractor is configured to extract an ENF signal of the electric network;
the entropy generation module is configured to generate first bit data based on the ENF signal; and
the entropy pool is configured to: receive at least one piece of input data, wherein the at least one piece of input data comprises the first bit data; and generate a random number based on the at least one piece of input data;
wherein the entropy pool comprises a first operational circuit and a deterministic random bit generator (DRBG), and the DRBG is separately connected to the output end of the entropy generation module and the first operational circuit;
the DRBG is configured to generate second bit data based on the first bit data; and
the first operational circuit is configured to perform an exclusive OR operation on the first bit data and the second bit data that are received from the entropy generation module, to generate the first random number, wherein the first random number is a true random number.

2. The random number generation apparatus according to claim 1, wherein:
the entropy pool further comprises a storage area and an interface circuit;
the DRBG is specifically configured to correspondingly generate at least one piece of third bit data based on the at least one piece of input data, wherein the at least one piece of third bit data comprises the second bit data;
the storage area is configured to store the at least one piece of third bit data; and
the interface circuit is configured to: after receiving a pseudo random number request message, randomly read third bit data from the storage area, and output a second random number based on the randomly read third bit data, wherein the second random number is a pseudo random number.

3. The random number generation apparatus according to claim 2, wherein:
the storage area comprises a first storage area and a second storage area;
the first storage area is configured to store third bit data that has an entropy rate greater than a first threshold;
the second storage area is configured to store third bit data that has an entropy rate not greater than the first threshold; and
the DRBG is further configured to: based on an entropy rate corresponding to the at least one piece of third bit data, store third bit data that is in the at least one piece of third bit data and that has an entropy rate greater than the first threshold into the first storage area, and store third bit data that is in the at least one piece of third bit data and that has an entropy rate not greater than the first threshold into the second storage area.

4. The random number generation apparatus according to claim 3, wherein the pseudo random number request message comprises a full-entropy pseudo random number request message and a reduced-entropy pseudo random number request message; and
the interface circuit is specifically configured to:
randomly read the third bit data from the first storage area after receiving the full-entropy pseudo random number request message; and
randomly read the third bit data from the second storage area after receiving the reduced-entropy pseudo random number request message.

5. The random number generation apparatus according to claim 1, wherein the entropy generation module comprises an analog-to-digital converter and a second operational circuit;
the analog-to-digital converter is configured to convert the ENF signal from an analog signal to a digital signal; and
the second operational circuit is configured to perform an operation on the ENF signal that is converted into the digital signal, to obtain the first bit data.

6. The random number generation apparatus according to claim 5, wherein the entropy generation module further comprises a preprocessing circuit, and the preprocessing circuit is separately connected to the ENF extractor and the analog-to-digital converter; and
the preprocessing circuit is configured to preprocess the ENF signal, and output the preprocessed ENF signal to the analog-to-digital converter.

7. The random number generation apparatus according to claim 6, wherein the preprocessing circuit is further configured to:
detect signal quality of the ENF signal; and
continue or stop, based on the signal quality of the ENF signal, outputting the ENF signal to the analog-to-digital converter.

8. The random number generation apparatus according to claim 1, wherein the random number generation apparatus is a chip.

9. A random number generation method, comprising:
obtaining at least one piece of input data, wherein the at least one piece of input data comprises first bit data, and the first bit data is generated based on an electric network frequency (ENF) signal; and
generating a random number based on the at least one piece of input data;
wherein the generating a random number based on the at least one piece of input data comprises:
generating second bit data based on the first bit data; and
performing an exclusive OR operation on the current first bit data and the second bit data, to generate the first random number, wherein the first random number is a true random number.

10. The random number generation method according to claim 9, wherein the generating second bit data based on the first bit data comprises:
correspondingly generating at least one piece of third bit data based on the at least one piece of input data, wherein the at least one piece of third bit data comprises the second bit data; and
after the correspondingly generating at least one piece of third bit data based on the at least one piece of input data, the method further comprises:
storing the at least one piece of third bit data; and
randomly reading third bit data from the at least one piece of stored third bit data after receiving a pseudo random number request message, and outputting a second random number based on the randomly read third bit data, wherein the second random number is a pseudo random number.

11. The random number generation method according to claim 10, wherein the storing the at least one piece of third bit data comprises:
based on an entropy rate corresponding to the at least one piece of third bit data, storing third bit data that is in the at least one piece of third bit data and that has an entropy rate greater than a first threshold into a first storage area, and storing third bit data that is in the at least one piece of third bit data and that has an entropy rate not greater than the first threshold into a second storage area.

12. The random number generation method according to claim 11, wherein the pseudo random number request message comprises a full-entropy pseudo random number request message and a reduced-entropy pseudo random number request message; and
the randomly reading third bit data from the at least one piece of stored third bit data after receiving a pseudo random number request message comprises:
randomly reading the third bit data from the first storage area after receiving the full-entropy pseudo random number request message; and
randomly reading the third bit data from the second storage area after receiving the reduced-entropy pseudo random number request message.

13. The random number generation method according to claim 9, wherein before the obtaining at least one piece of input data, the method further comprises:
converting the ENF signal from an analog signal into a digital signal; and
performing an operation on the ENF signal that is converted into the digital signal, to obtain the first bit data.

14. The random number generation method according to claim 13, wherein before the converting the ENF signal from an analog signal to a digital signal, the method further comprises:
preprocessing the ENF signal.

15. The random number generation method according to claim 14, wherein before the converting the ENF signal from an analog signal to a digital signal, the method further comprises:
detecting signal quality of the ENF signal; and
continuing or stopping, based on the signal quality of the ENF signal, converting the ENF signal from an analog signal to a digital signal.

16. A electric device comprising a random number generation apparatus, wherein the random number generation apparatus comprises an electric network frequency (ENF) extractor, an entropy generation module, and an entropy pool, wherein an input end of the ENF extractor is connected to an electric network, an output end of the ENF extractor is connected to an input end of the entropy generation module, and an output end of the entropy generation module is connected to the entropy pool;
the ENF extractor is configured to extract an ENF signal of the electric network;
the entropy generation module is configured to generate first bit data based on the ENF signal; and
the entropy pool is configured to: receive at least one piece of input data, wherein the at least one piece of input data comprises the first bit data; and generate a random number based on the at least one piece of input data;
wherein the entropy pool comprises a first operational circuit and a deterministic random bit generator (DRBG), and the DRBG is separately connected to the output end of the entropy generation module and the first operational circuit;
the DRBG is configured to generate second bit data based on the first bit data; and
the first operational circuit is configured to:
perform an exclusive OR operation on the first bit data and the second bit data that are received from the entropy generation module, to generate the first random number, wherein the first random number is a true random number.

17. The electric device according to claim 16, wherein the entropy pool further comprises a storage area and an interface circuit;
the DRBG is specifically configured to correspondingly generate at least one piece of third bit data based on the at least one piece of input data, wherein the at least one piece of third bit data comprises the second bit data;
the storage area is configured to store the at least one piece of third bit data; and
the interface circuit is configured to: after receiving a pseudo random number request message, randomly read third bit data from the storage area, and output a second random number based on the randomly read third bit data, wherein the second random number is a pseudo random number.

18. The electric device according to claim 17, wherein the storage area comprises a first storage area and a second storage area;
the first storage area is configured to store third bit data that has an entropy rate greater than a first threshold;
the second storage area is configured to store third bit data that has an entropy rate not greater than the first threshold; and
the DRBG is further configured to: based on an entropy rate corresponding to the at least one piece of third bit data, store third bit data that is in the at least one piece of third bit data and that has an entropy rate greater than the first threshold into the first storage area, and store third bit data that is in the at least one piece of third bit data and that has an entropy rate not greater than the first threshold into the second storage area.

19. The electric device according to claim 18, wherein the pseudo random number request message comprises a full-entropy pseudo random number request message and a reduced-entropy pseudo random number request message; and
the interface circuit is specifically configured to:
randomly read the third bit data from the first storage area after receiving the full-entropy pseudo random number request message; and
randomly read the third bit data from the second storage area after receiving the reduced-entropy pseudo random number request message.

20. The electric device according to of claim 16, wherein the electric device comprises one of the following:
a vehicle;
an Internet of things, IoT, device; or
a smart appliance.
